(19) United States
(12) Patent Application Publication
(10) Pub. No.: US 2025/0337304 A1
(43) Pub. Date: Oct. 30, 2025

(54) ROTOR OF AN ELECTRICAL ASYNCHRONOUS MACHINE AND METHOD FOR DETERMINING THE ROTATIONAL POSITION OF THE ROTOR

(71) Applicant: AUDI AG, Ingolstadt (DE)

(72) Inventors: Bastian HEIDLER, Kranzberg (DE); Benjamin LEHNER, Ingolstadt (DE)

(21) Appl. No.: 19/181,070

(22) Filed: Apr. 16, 2025

(30) Foreign Application Priority Data
Apr. 30, 2024 (DE) 102024112163.7

(51) Int. Cl. H02K 17/16; H02K 3/04; H02K 11/21; H02K 11/26

(52) U.S. Cl. CPC H02K 17/16; H02K 3/04; H02K 11/21; H02K 11/26

(57) ABSTRACT

A rotor of an electrical asynchronous machine is provided, the rotor comprising a rotor shaft which extends along an axis of rotation, a rotor laminated core which is directly or indirectly connected to the rotor shaft, a plurality of rotor bars which extend in the direction of the axis of rotation and are distributed in the circumferential direction about the axis of rotation, and at least one short-circuit ring which connects all rotor bars to one another in an electrically conductive manner. The plurality of rotor bars comprises at least three different rotor bars, which differ from one another in terms of their width in each case. An electrical asynchronous machine having a rotor, and a method for determining the rotational position of the rotor are also provided.

### BACKGROUND

### Technical Field

The disclosure relates to a rotor of an electrical asynchronous machine, comprising a rotor shaft which extends along an axis of rotation, a rotor laminated core which is directly or indirectly connected to the rotor shaft, a plurality of rotor bars which extend in the direction of the axis of rotation and are distributed in the circumferential direction about the axis of rotation, and at least one short-circuit ring which connects all of the rotor bars to one another in an electrically conductive manner. The plurality of rotor bars comprises at least three different rotor bars which differ from one another in terms of their width in each case. The disclosure further relates to an electrical asynchronous machine having a rotor, and a method for determining the rotational position of the rotor.

### Description of the Related Art

In electrical asynchronous machines, alternating current is applied to windings in a stator, which generates a magnetic field, which in turn induces a voltage in the rotor. The current flow through the short-circuit ring in the rotor in turn generates a magnetic field, which, together with the magnetic field of the stator, causes a torque and thus a rotation of the rotor. Such electrical machines can also be referred to as induction machines. In order to be able to determine the rotational position of the rotor in the stator, a rotor position sensor is usually arranged on the rotor in asynchronous machines. A sensor is provided on the stator, which, after a learning process, detects the position of the rotor position sensor rotating with the rotor. The rotational positions of the rotor can then be deduced from the sensor signals. The provision of the rotor position sensor and the sensor increases the complexity of the electrical machine and requires effort for the learning process.

DE 694 32 226 T2 describes a method and a device for the sensorless determination of the position and speed of a rotor of an AC motor. In the method, the rotational position of the rotor relative to the stator is determined by measuring the impedance of the rotor during operation.

US 2014/0246940 A1 describes an electric motor and a motor system. The rotor of the motor has several permanent magnets whose magnetic properties change in the circumferential direction about the rotor shaft. These different magnetic properties are used to determine the rotational positions of the rotor.

US 2003/0102762 A1 describes electrical, permanent magnet synchronous machines and methods for their manufacture. The rotor of such a synchronous machine can have slots which are arranged at different distances from the axis of rotation of the rotor.

### BRIEF SUMMARY

The present disclosure provides solutions with which the rotational position of a rotor of an electrical asynchronous machine can be determined simply and at the same time precisely.

According to an embodiment, a rotor of an electrical asynchronous machine is provided, the rotor comprising:
a rotor shaft which extends along an axis of rotation,
a rotor laminated core which is directly or indirectly connected to the rotor shaft, wherein the rotor laminated core comprises a plurality of individual sheets which are each oriented perpendicular to the axis of rotation and abut on one another in parallel in the direction of the axis of rotation,
a plurality of rotor bars which extend in the direction of the axis of rotation and are distributed in the circumferential direction about the axis of rotation, in particular regularly, wherein each rotor bar is arranged in a rotor slot which penetrates the rotor laminated core in the direction of the axis of rotation,
at least one short-circuit ring which connects all rotor bars to one another in an electrically conductive manner,
wherein the plurality of rotor bars comprises at least three different rotor bars, that is to say at least one first rotor bar having a first width, at least one second rotor bar having a second width and at least one third rotor bar having a third width, wherein the width is defined as the maximum extension of the respective rotor bar in the circumferential direction about the axis of rotation, wherein the first width, the second width and the third width each differ from one another.

The rotor according to the disclosure is provided for use in an electrical asynchronous machine. The inductive properties of the rotor are designed asymmetrically in the circumferential direction about its axis of rotation. Due to these asymmetrically distributed inductive properties, the rotational position of the rotor can be determined in a simple manner using the method according to the disclosure described later.

The rotor according to the disclosure comprises a rotor shaft which extends along an axis of rotation. The axis of rotation is the axis about which the rotor rotates during operation. The rotor further comprises a rotor laminated core which is made up of a plurality of sheets which are directly or indirectly connected to the rotor shaft. The sheets are arranged parallel to one another and are electrically insulated from one another, for example, by applying a varnish to the respective surface of the sheets. The rotor further comprises a plurality of rotor bars which penetrate the rotor laminated core and which are arranged in the rotor laminated core. When the rotor is in operation, a current is generated in the rotor bars by a magnetic field which is generated by the stator. The rotor bars can comprise copper or aluminum, for example. Each rotor bar is arranged in a rotor slot. A rotor slot is a recess in the rotor laminated core into which the respective rotor bar is inserted. In the circumferential direction, the rotor bars are preferably arranged regularly, i.e., at constant distances from one another. The plurality of rotor bars together form a cage. The rotor further comprises at least one short-circuit ring, which connects all rotor bars in an electrically conductive manner in the circumferential direction about the axis of rotation. In some instances, two such short-circuit rings are provided, each of which is arranged on an end face of the rotor bars.

According to the disclosure, the rotor bars differ from one another in terms of their geometry. The plurality of rotor bars comprises at least three types of rotor bars, which are dimensioned differently. Hereinafter, a rotor bar is also understood to mean a type of rotor bar. For example, a first rotor bar is also understood to mean a first type of rotor bar. The first rotor bar can be provided as just one or several rotor bars of the same type. A first rotor bar has a first width, a second rotor bar has a second width, and a third rotor bar has a third width. Width is defined as the maximum extension of the respective rotor bar in the circumferential direction about the axis of rotation. The first width, the second width, and the third width differ from one another, which means that the first rotor bar, the second rotor bar, and the third rotor bar have different dimensions. Due to the different geometric dimensions, the inductive properties of these rotor bars also differ from one another. Their impedance when exposed to a magnetic field generated by the stator differs from one another. These different inductive properties of the first rotor bar, the second rotor bar and the third rotor bar can be utilized to determine the rotational position of the rotor in a simple manner using the method according to the disclosure. Due to the different widths, the rotor bars have a different scattering structure. If different rotor bars are arranged at different positions in the circumferential direction about the axis of rotation, the rotor is provided with an anisotropic inductive behavior. This anisotropic inductive behavior is sufficient to determine the rotational position of the rotor without the need to provide an additional rotor position sensor and a sensor. This reduces the number of components of the rotor or an electrical asynchronous machine to which the rotor belongs. In addition, the rotor according to the disclosure saves effort and time for teaching a sensor. A further advantage of the rotor according to the disclosure is that no signal lines are required to transmit the sensor signals between the electrical asynchronous machine and the associated power electronics. Saving such signal lines improves the electromagnetic compatibility (EMC) of the electrical machine or its control electronics. In addition, the rotor according to the disclosure enables a very precise determination of its rotational position relative to the stator.

In one embodiment, it is provided that at least three different rotor bars are arranged adjacent to one another in the circumferential direction about the axis of rotation. It is provided that at least three different rotor bars having different widths are arranged directly adjacent to one another in the circumferential direction. The width of the rotor bars differs from one rotor bar to the other. Due to these different widths of rotor bars arranged directly next to one another, a sine pole of the impedance of the rotor is formed asymmetrically at this point. This sine pole can be utilized particularly well in the method to determine the rotational position of the rotor.

In a further embodiment, it is provided that a first rotor bar is arranged in the circumferential direction about the axis of rotation between two second rotor bars and these two second rotor bars are arranged in the circumferential direction about the axis of rotation between two third rotor bars. In this embodiment, a total of at least five rotor bars having different widths are arranged directly adjacent to one another. In this case, a single first rotor bar is surrounded in the circumferential direction by a pair of second rotor bars, which in turn is surrounded by a pair of third rotor bars. In this way, a sine pole of the impedance is generated particularly well. Of course, it is also possible to arrange an even larger number of rotor bars having different widths next to one another or adjacent to one another in the circumferential direction. The first width of the first rotor bar arranged in the middle is preferably smaller than the second width of the rotor bars arranged adjacent to it, which in turn is smaller than the width of the third rotor bars arranged adjacent thereto. However, a reverse arrangement is also possible, in which the first width of the first rotor bar arranged in the middle is greater than the second width of the second rotor bars, which in turn is greater than the third width of the third rotor bars arranged at the very outside.

In one embodiment, it is provided that the at least three different rotor bars have a cross-sectional area of equal size in a sectional plane perpendicular to the axis of rotation, in particular wherein all rotor bars have a cross-sectional area of equal size in a sectional plane perpendicular to the axis of rotation. It is provided that at least all different rotor bars having different widths have a cross-sectional area of equal size in a sectional plane perpendicular to the axis of rotation. This cross-sectional area of equal size ensures equal current-carrying capacity of all rotor bars. This prevents uneven heating of the rotor during operation. Furthermore, each rotor bar generates the same torque during operation, which results in favorable concentricity properties of the rotor or the electrical asynchronous machine. Since the different rotor bars have different widths, another dimension of the different rotor bars must be changed inversely proportionally to produce a cross-sectional area of equal size. One such embodiment is described below.

In one embodiment, it is provided that the at least one first rotor bar has a first thickness, the at least one second rotor bar has a second thickness and the at least one third rotor bar has a third thickness, wherein the thickness is defined as the maximum extension of the respective rotor bar radially to the axis of rotation, wherein the first thickness, the second thickness and the third thickness differ from one another. In this embodiment, the different rotor bars differ not only in their width but also in their thickness. The widths are inversely proportional to the thicknesses in this case. This means that for a first rotor bar having a first width that is greater than a second width of a second rotor bar, the first thickness of the first rotor bar is correspondingly smaller than the second thickness of the second rotor bar. The same applies in reverse, of course, in a case in which the first width is smaller than the second width. In this case, the first thickness is greater than the second thickness. By selecting the dimensions thickness and width in this way, it can be easily ensured that all rotor bars have the same cross-sectional area in a plane perpendicular to the axis of rotation.

According to another embodiment, an electrical asynchronous machine is provided, the electrical asynchronous machine comprising:
a rotor according to one of the previously described embodiments,
and a stator which has a stator laminated core, wherein the stator laminated core comprises a plurality of individual sheets, which are each oriented perpendicular to the axis of rotation and abut on one another in parallel in the direction of the axis of rotation, and wherein the stator has a plurality of stator windings which are arranged at least in sections in the stator laminated core, wherein the rotor is mounted in the stator so as to be rotatable about the axis of rotation,
a power electronics unit which is electrically connected to the stator windings and is configured to apply alternating voltages to the stator windings as required,
wherein, when alternating voltages are applied to the stator windings by the power electronics, a current flow is established in the rotor, in particular in the rotor bars, according to an impedance which is distributed asymmetrically in the circumferential direction about the axis of rotation, wherein the impedance of the rotor at a circumferential position about the axis of rotation at which the at least three different rotor bars are arranged differs from the impedance of the rotor at a circumferential position about the axis of rotation where none of the at least three different rotor bars are arranged.

The electrical asynchronous machine according to the disclosure comprises a rotor according to any one of the previously described embodiments, which has at least three different rotor bars having different widths. The electrical asynchronous machine according to the disclosure further comprises a stator, which comprises a stator laminated core with a plurality of individual sheets. A plurality of stator windings, to which an alternating current can be applied, are arranged within the stator laminated core. The rotor is mounted in the stator so as to be rotatable about the axis of rotation. Furthermore, power electronics are provided, which is electrically connected to the stator windings and applies an alternating voltages to the stator windings during operation. The power electronics is in turn connected to a control unit, which transmits control signals to the power electronics in order to generate a three-phase voltage system depending on the operating point, which applies alternating voltages to the stator windings. The control system has the task of setting the speed and torque of the electrical asynchronous machine. When alternating voltages are applied to the stator windings, a current flow is established in the stator windings, which generates a time-varying magnetic field, which induces voltages in the rotor, in particular in its rotor bars, which result in a current flow in the said rotor bars. The impedance of the rotor is distributed asymmetrically about the axis of rotation, since different rotor bars having different widths are provided. In the area of these different rotor bars having different widths, the rotor has an impedance that differs from other circumferential positions about the axis of rotation where no different rotor bars are arranged. This difference in the impedance or the magnetic behavior of the rotor in the circumferential direction about the axis of rotation can be utilized to determine the rotational position of the rotor in the stator without additional electrical components, such as sensors. The electrical asynchronous machine according to the disclosure therefore has a reduced number of components compared to known solutions and therefore has a simple structure. At the same time, it is possible to determine the rotational position of the rotor precisely.

In one embodiment of the electrical asynchronous machine, it is provided that at least one signal generating unit and at least one measuring unit are provided, wherein the signal generating unit is configured to generate a measuring signal for determining the rotational position of the rotor and to transmit it to the stator windings, and the measuring unit is configured to detect a response signal from the stator windings, wherein the measuring unit is configured to determine the rotational position of the rotor from the measuring signal and the response signal. In this embodiment, the electrical asynchronous machine comprises a signal generating unit which is configured to transmit a high-frequency measuring signal to the power electronics or to the stator windings. This measuring signal is superimposed on the alternating voltages required for operation, which are applied to the stator windings by the power electronics. Furthermore, a measuring unit is provided which is configured to detect a response signal from the stator windings. The response signal is superimposed on the alternating current which is transmitted between the power electronics and the stator. The measuring unit is further configured to determine the rotational position of the rotor in the stator from the response signal and the measurement signal. This determination of the rotational position may be advantageously carried out according to the method according to the disclosure.

According to another embodiment, a method for determining the rotational position of the rotor of an electrical asynchronous machine is provided, the method including:
A) generating a measuring signal by the signal generation unit and transmitting the measuring signal to the stator windings, the measuring signal being formed by a voltage signal,
B) transmitting a response signal from the stator windings to the measuring unit, the response signal being formed by a current signal, and
C) determining the rotational position of the rotor by the measuring unit from the response signal.

The method according to the disclosure is provided to determine the rotational position of the rotor in the stator simply and precisely. An electrical asynchronous machine according to the disclosure may be used to carry out the method. The method according to the disclosure may be carried out in the order of method steps A) to C).

In a first method step A), a measurement signal is generated by the signal generation unit. This measurement signal is transmitted from the signal generation unit, in particular via the power electronics, to the stator windings. The measurement signal is formed by a voltage signal, which may have a significantly higher frequency than the frequency with which the power electronics transmits alternating current to the stator windings. The measurement signal causes an induction of a current in the rotor. The current induced in the rotor in turn causes a current response in the stator with a high frequency, which represents a response signal to the measurement signal.

In a second method step B), the response signal, which is generated inductively on the basis of the previously transmitted measurement signal, is transmitted to the measuring unit. The response signal is formed by a high-frequency current signal, which is detected by the measuring unit.

In a third method step C), the measuring unit determines the rotational position of the rotor in the stator. This determination is made on the basis of the response signal transmitted in method step B). This evaluation, which can be carried out using a demodulation algorithm, can be used to deduce the geometric rotational position of the rotor.

No additional components, such as sensors or rotor position sensors, are required to carry out the method according to the disclosure. This means that it is not necessary to teach one or more sensors in a complex teaching process to determine the rotational position. The method according to the disclosure can therefore easily and precisely determine the rotational position of the rotor.

In one embodiment of the method, it is provided that the measurement signal is formed by a square wave signal or a sine wave signal and/or the measurement signal is in a range between 1 kHz and 10 kHz. In this embodiment, the measurement signal is formed by a voltage signal which, viewed over time, is a square wave signal or a sine wave signal. Depending on the shape of the measurement signal, a corresponding response signal in the same shape is generated in the rotor and stator of the electrical asynchronous machine. If the measurement signal is formed by a square wave signal, the response signal generated is also a square wave signal. The same applies if the measurement signal is formed by a sine wave signal; in this case, the response signal is also formed by a sine wave signal. The frequency of the measurement signal is between 1 kHz and 10 kHz. In this way, the measurement signal can be easily distinguished from other signals during operation of the electrical asynchronous machine. The frequency range mentioned is below the clock frequency of an inverter, which is approximately between 10 and 20 kHz. Furthermore, the frequency range mentioned is above the frequency that the controller uses to control the power electronics. This frequency is no higher than 1 kHz.

In one embodiment, it is provided that in method step C) the determination of the rotational position takes place as a function of time, in particular wherein the method is carried out continuously during operation of the asynchronous machine. By determining the rotational position as a function of time, the current rotational position of the rotor can always be deduced. In addition, it is possible to predict future rotational positions of the rotor. Advantageously, the entire method may be carried out continuously during operation of the electrical asynchronous machine. In this way, the current rotational position of the rotor in the stator is always known.

Features, effects and advantages which are disclosed in connection with the rotor and the electrical asynchronous machine are also deemed to be disclosed in connection with the method. The same applies vice versa; features, effects and advantages which are disclosed in connection with the method are also deemed to be disclosed in connection with the rotor and the electrical asynchronous machine.

### BRIEF DESCRIPTION OF THE SEVERAL VIEWS OF THE DRAWINGS

The disclosure is illustrated schematically in the drawings using embodiments and is further described with reference to the drawings. In the drawings:

FIG. 1 shows a schematic, sectional side view of a portion of an electrical asynchronous machine according to an embodiment of the disclosure,

FIG. 2 shows a schematic view of an electrical asynchronous machine according to an embodiment of the disclosure.

The figures are described in a coherent and comprehensive manner. The same reference symbols are assigned to the same components.

### DETAILED DESCRIPTION

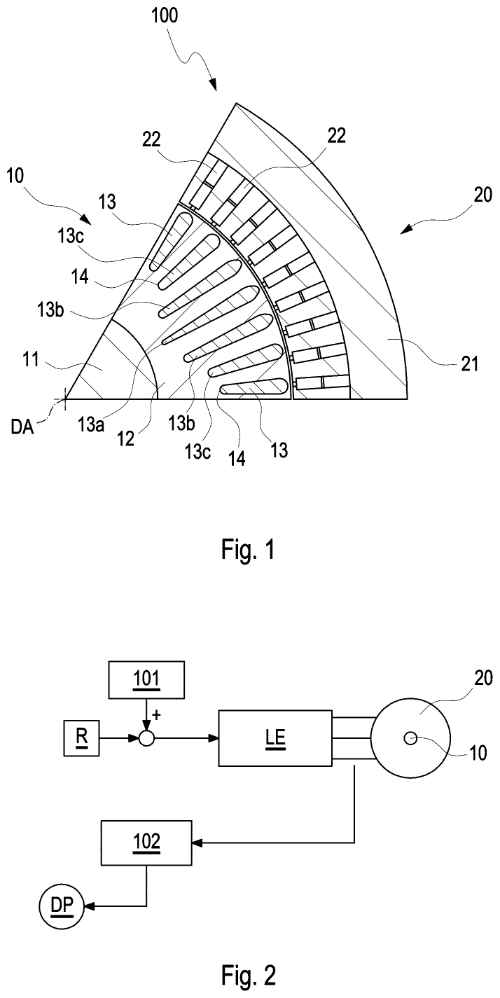

FIG. 1 shows a schematic, sectional side view of a portion of an electrical asynchronous machine 100 according to an embodiment of the disclosure. By way of example, FIG. 1 shows a sector of electrical asynchronous machine 100. On the right-hand side, the stator 20 is shown in section, which has a stator laminated core 21 that is formed by a plurality of individual sheets. Furthermore, a plurality of stator windings 22 can be seen, which are arranged in stator laminated core 21. On the left-hand side, a sector of rotor 10 is shown. There is an air gap between rotor 10 and stator 20. Rotor 10 is mounted in stator 20 with its rotor shaft 11 so as to be rotatable about the axis of rotation DA. Rotor 10 comprises a rotor laminated core 12, which in turn comprises a plurality of individual sheets. These sheets are each oriented perpendicular to the axis of rotation DA and abut on one another in parallel in the direction of the axis of rotation DA. In rotor laminated core 12, several rotor slots 14 are distributed regularly in the circumferential direction. These rotor slots 14 penetrate rotor laminated core 12 in the direction of axis of rotation DA. A rotor bar 13, 13a, 13b, 13c is arranged in each rotor slot 14. In the embodiment shown, one rotor bar 13, 13a, 13b, 13c completely fills a rotor slot 14 in each case. A first rotor bar 13a having a first width in the circumferential direction about axis of rotation DA can be seen in the middle of the sector of rotor 10 shown. This first rotor bar 13a is arranged in the circumferential direction about axis of rotation DA between two second rotor bars 13b, each of which has a second width. In the embodiment shown, the first width is smaller than the second width. The two second rotor bars 13b are arranged in the circumferential direction about the axis of rotation DA between two third rotor bars 13c which have a third width. In the embodiment shown, the third width is greater than the second width. The two third rotor bars 13c are arranged between further rotor bars 13, which have a width that is greater than the width of third rotor bars 13c. In the sector shown, the width of rotor bars 13, 13a, 13b, 13c arranged next to one another is thus reduced in the circumferential direction, initially starting from rotor bar 13 to first rotor bar 13a. Further in the circumferential direction about axis of rotation DA, the width then increases again from first rotor bar 13a to rotor bar 13. In this way, an anisotropic inductive behavior of rotor 10 arises in the sector shown. In the embodiment shown, all other rotor bars 13 that are not shown are of the same type as rotor bars 13 shown on the outside. The different widths in the sector shown or the resulting different distances between adjacent rotor bars 13, 13a, 13b, 13c from one another cause the anisotropic inductive behavior of the rotor in the magnetic field of stator 20, which can be utilized with the method according to the disclosure to determine rotational position DP of rotor 10. In the embodiment shown, the continuously changing widths of rotor bars 13, 13a, 13b, 13c inductively form a sine pole, which is particularly suitable for an accurate determination of rotational position DP of rotor 10 in the method according to the disclosure.

All rotor bars 13, 13a, 13b, 13c have the same cross-sectional area in the illustrated section plane perpendicular to the axis of rotation DA. This ensures an equal current-carrying capacity of all rotor bars 13, 13a, 13b, 13c and that there is therefore no unevenly distributed heating during operation. The thickness of rotor bars 13, 13a, 13b, 13c is defined radially to the axis of rotation DA. In order to achieve a cross-sectional area of equal size for all rotor bars 13, 13a, 13b, 13c, this thickness is inversely proportional to the previously described width in the circumferential direction about the axis of rotation. It can be readily seen that first rotor bar 13a having the smallest width has the greatest thickness. Accordingly, rotor bars 13, 13a, 13b, 13c having a different width also have a different thickness. Rotor slots 14, in which respective rotor bars 13, 13a, 13b, 13c are arranged, have a width and thickness which corresponds to the width and thickness of the rotor bars 13, 13a, 13b, 13c arranged therein.

FIG. 2 shows a schematic view of an electrical asynchronous machine 100 according to an embodiment of the disclosure. FIG. 2 shows an embodiment of electrical asynchronous machine 100 schematically, but in a different way than in FIG. 1. FIG. 2 enables a description of the electrical and electronic components of electrical asynchronous machine 100, whereas FIG. 1 primarily shows their geometric structure. Stator 20 and rotor 10 are shown symbolically on the right-hand side in FIG. 2. Stator 20 and its stator windings 22 are electrically connected to power electronics LE. When the electrical asynchronous machine 100 is in operation, power electronics LE applies alternating voltages to stator windings 22, which result in an alternating current in the windings of stator 22. This alternating current in stator 20 in turn leads to a time-varying magnetic field, which induces voltages in rotor 10, which in turn result in a current flow in rotor bars 13, 13a, 13b, 13c. This current in turn results in a magnetic field in rotor 10, which in combination with the magnetic field of stator 20 generates a torque of rotor 10 and thus causes it to rotate. The speed is controlled or regulated by controller R, which is shown on the far left-hand side. Controller R transmits control signals for generating the alternating voltages to power electronics LE, which in turn applies alternating voltages to stator 20, in particular its windings 22. To determine rotational position DP of rotor 10, a signal generation unit 101 is provided, which generates a high-frequency measurement signal. This measurement signal is superimposed on the signal from controller R and transmitted to power electronics LE. This means that the measurement signal is also transmitted to stator 20 and rotor 10. At the bottom of FIG. 2, a measuring unit 102 is shown, which measures and analyzes the electrical currents flowing between power electronics LE and stator 20. Measuring unit 102 is configured to recognize and extract the response signal from stator 20 and rotor 10 to the measurement signal generated by signal generation unit 101 in the analyzed electrical currents. Furthermore, measuring unit 102 is configured to determine rotational position DP of rotor 10 by comparing the measurement signal and the response signal, and to output it to other electrical or electronic components (not shown).

German patent application no. 102024112163.7 filed Apr. 30, 2024, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A rotor of an electrical asynchronous machine, comprising
a rotor shaft which extends along an axis of rotation;
a rotor laminated core which is directly or indirectly connected to the rotor shaft, wherein the rotor laminated core comprises a plurality of individual sheets which are each oriented perpendicular to the axis of rotation and abut on one another in parallel in a direction of the axis of rotation;
a plurality of rotor bars which extend in the direction of the axis of rotation and are distributed in a circumferential direction about the axis of rotation, wherein each rotor bar is arranged in a rotor slot which penetrates the rotor laminated core in the direction of the axis of rotation; and
at least one short-circuit ring which connects all rotor bars to one another in an electrically conductive manner,
wherein the plurality of rotor bars comprises at least three different rotor bars, including at least one first rotor bar having a first width, at least one second rotor bar having a second width and at least one third rotor bar having a third width, wherein each width is defined as the maximum extension of the respective rotor bar in the circumferential direction about the axis of rotation, and wherein the first width, the second width and the third width each differ from one another.

2. The rotor according to claim 1, wherein the at least three different rotor bars are arranged adjacent to one another in the circumferential direction about the axis of rotation.

3. The rotor according to claim 1, wherein the first rotor bar is arranged in the circumferential direction about the axis of rotation between two second rotor bars and the two second rotor bars are arranged in the circumferential direction about the axis of rotation between two third rotor bars.

4. The rotor according to claim 1, wherein the at least three different rotor bars have a cross-sectional area of equal size in a sectional plane perpendicular to the axis of rotation.

5. The rotor according to claim 4, wherein all rotor bars have a cross-sectional area of equal size in the sectional plane perpendicular to the axis of rotation.

6. The rotor according to claim 1, wherein the at least one first rotor bar has a first thickness, the at least one second rotor bar has a second thickness and the at least one third rotor bar has a third thickness, wherein each thickness is defined as the maximum extension of the respective rotor bar radially to the axis of rotation, wherein the first thickness, the second thickness and the third thickness differ from one another.

7. An electrical asynchronous machine, comprising:
a rotor including:
a rotor shaft which extends along an axis of rotation;
a rotor laminated core which is directly or indirectly connected to the rotor shaft, wherein the rotor laminated core comprises a plurality of individual sheets which are each oriented perpendicular to the axis of rotation and abut on one another in parallel in a direction of the axis of rotation;
a plurality of rotor bars which extend in the direction of the axis of rotation and are distributed in a circumferential direction about the axis of rotation, wherein each rotor bar is arranged in a rotor slot which penetrates the rotor laminated core in the direction of the axis of rotation; and
at least one short-circuit ring which connects all rotor bars to one another in an electrically conductive manner,
wherein the plurality of rotor bars comprises at least three different rotor bars, including at least one first rotor bar having a first width, at least one second rotor bar having a second width and at least one third rotor bar having a third width, wherein each width is defined as the maximum extension of the respective rotor bar in the circumferential direction about the axis of rotation, and wherein the first width, the second width and the third width each differ from one another;
a stator which has a stator laminated core, wherein the stator laminated core comprises a plurality of individual sheets, which are each oriented perpendicular to the axis of rotation and abut on one another in parallel in the direction of the axis of rotation, and wherein the stator has a plurality of stator windings which are arranged at least in sections in the stator laminated core, wherein the rotor is mounted in the stator so as to be rotatable about the axis of rotation; and
a power electronics which is electrically connected to the stator windings and is configured to apply alternating voltages to the stator windings as required,
wherein, when alternating voltages are applied to the stator windings by the power electronics, a current flow is established in the rotor bars of the rotor according to an impedance which is distributed asymmetrically in the circumferential direction about the axis of rotation, wherein the impedance of the rotor at a circumferential position about the axis of rotation at which the at least three different rotor bars are arranged differs from the impedance of the rotor at a circumferential position of the axis of rotation where none of the at least three different rotor bars are arranged.

8. The electrical asynchronous machine according to claim 7, wherein at least one signal generating unit and at least one measuring unit are provided, wherein the signal generating unit is configured to generate a measuring signal for determining a rotational position of the rotor and to transmit the measuring signal to the stator windings, and the measuring unit is configured to detect a response signal from the stator windings, wherein the measuring unit is configured to determine the rotational position of the rotor from the measuring signal and the response signal.

9. A method for determining a rotational position of a rotor of an electrical asynchronous machine, the electrical asynchronous machine comprising:
the rotor, the rotor including:
a rotor shaft which extends along an axis of rotation;
a rotor laminated core which is directly or indirectly connected to the rotor shaft, wherein the rotor laminated core comprises a plurality of individual sheets which are each oriented perpendicular to the axis of rotation and abut on one another in parallel in a direction of the axis of rotation;
a plurality of rotor bars which extend in the direction of the axis of rotation and are distributed in a circumferential direction about the axis of rotation, wherein each rotor bar is arranged in a rotor slot which penetrates the rotor laminated core in the direction of the axis of rotation; and
at least one short-circuit ring which connects all rotor bars to one another in an electrically conductive manner,
wherein the plurality of rotor bars comprises at least three different rotor bars, including at least one first rotor bar having a first width, at least one second rotor bar having a second width and at least one third rotor bar having a third width, wherein each width is defined as the maximum extension of the respective rotor bar in the circumferential direction about the axis of rotation, and wherein the first width, the second width and the third width each differ from one another;
a stator which has a stator laminated core, wherein the stator laminated core comprises a plurality of individual sheets, which are each oriented perpendicular to the axis of rotation and abut on one another in parallel in the direction of the axis of rotation, and wherein the stator has a plurality of stator windings which are arranged at least in sections in the stator laminated core, wherein the rotor is mounted in the stator so as to be rotatable about the axis of rotation; and
a power electronics which is electrically connected to the stator windings and is configured to apply alternating voltages to the stator windings as required, and
wherein the method comprises:
generating a measuring signal by a signal generating unit and transmitting the measuring signal to the stator windings, the measuring signal being formed by a voltage signal,
transmitting a response signal from the stator windings to a measuring unit, the response signal being formed by a current signal, and
determining the rotational position of the rotor by the measuring unit from the response signal.

10. The method according to claim 9, wherein the measurement signal is formed by a square wave signal or a sine wave signal, and/or the measurement signal is in a range between 1 kHz and 10 kHz.

11. The method according to claim 9, wherein the determining of the rotational position of the rotor takes place as a function of time.

12. The method according to claim 11, wherein the method is carried out continuously during operation of the asynchronous machine.
